(19) United States
(12) Patent Application Publication
(10) Pub. No.: US 2010/0104015 A1
(43) Pub. Date: Apr. 29, 2010

(54) Method and apparatus for transrating compressed digital video

(76) Inventors: Chanchal Chatterjee, Encinitas, CA (US); Robert Owen Eifrig, SanDiego, CA (US)

Correspondence Address: Robert F. Gazdzinski, Esq.;Gazdzinski & Associates, PC, Suite 375, 11440 West Bernardo Court, San Diego, CA, 92127, US

(21) Appl. No.: 12/322,887

(22) Filed: Feb. 9, 2009

Related U.S. Application Data
(60) Provisional application No. 61/197,216, filed on Oct. 24, 2008.

(51) Int. Cl. H04N 7/26

(52) U.S. Cl. 375/240.16; 375/240.01; 375/E07.198; 375/E07.104

(57) ABSTRACT

Apparatus and methods for transcoding one or more compressed video bitstreams. In one embodiment, the method comprises partially decoding an input video bitstream to produce a partially decoded intermediate video bitstream generated without performing a deblocking operation, extracting syntax pass-through information from the input video bitstream, and producing an output video bitstream from the intermediate video bitstream by using, for each macroblock, the macroblock decision from the input video bitstream.

### PRIORITY AND RELATED APPLICATIONS

This application claims priority to co-owned and co-pending U.S. provisional patent application Serial No. 61/197,216 filed Oct. 24, 2008 entitled “Method And Apparatus For Transrating Compressed Digital Video”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to the field of digital video encoding and, more particularly in one exemplary aspect to methods and systems of changing bitrate of a digital video bitstream.

2. Description of the Related Technology

Since the advent of Moving Pictures Expert Group (MPEG) digital audio/video encoding specifications, digital video is ubiquitously used in today's information and entertainment networks. Example networks include satellite broadcast networks, digital cable networks, over-the-air television broadcasting networks, and the Internet.

Furthermore, several consumer electronics products that utilize digital audio/video have been introduced in the recent years. Some examples included digital versatile disk (DVD), MP3 audio players, digital video cameras, etc.

Such proliferation of digital video networks and consumer products has led to an increased need for a variety of products and methods that perform storage or processing of digital video. One such example of video processing is changing the bitrate of a compressed video bitstream. Such processing may be used, for example, to change the bitrate of a digital video program stored on a personal video recorder (PVR) at the bitrate received from a broadcast video network, to the bitrate of a home network to which the program is being sent. Changing the bitrate of a video program is also performed in other video distribution networks such as digital cable networks, or an Internet protocol television (IPTV) distribution network.

In conventional approaches, one simple way to change the bitrate is by decoding received video bitstream into an uncompressed video stream, and then re-encoding the uncompressed video to a desired output rate. While conceptually easy, this method is practically inefficient because of the need to implement a computationally expensive video encoder to perform bitrate changes, i.e., transrating.

Several transrating techniques have been proposed for the MPEG-2 video compression format. With the recent introduction of advanced video codecs such as VC-1, also known as the 421M video encoding standard of the Society of Motion Picture and Television Engineering (SMPTE), and H.264, the problem of transrating has become even more complex. Broadly speaking, it takes much higher amounts of computations to encode video to one of the advanced video codecs. Similarly, decoding an advanced video codec bitstream is computationally more intensive than first generation video encoding standards. As a result of increased complexity, transrating requires a higher amount of computations. Furthermore, due to wide scale proliferation of multiple video encoding schemes (e.g., VC-1 and H.264), seamless functioning of consumer video equipment requires transcoding from one encoding standard to another, besides transrating to an appropriate bitrate.

While the computational complexity requirements have increased due to sophisticated video compression techniques, the need for less complex and efficient transrating solutions has also increased due to the proliferation of digital video deployments, and increased number of applications where transrating is employed in a digital video system. Many consumer devices, which are traditionally cost sensitive, also require transrating.

Hence, there is a salient need for improved methods and apparatus that enable lower complexity transrating of digital video streams in an efficient and cost effective manner. Such improved methods and apparatus will also ideally be compatible with extant (legacy) processing platforms and protocols, as well as with newer and future implementations.

### SUMMARY OF THE INVENTION

The present invention satisfies the foregoing needs by providing improved methods and apparatus for video transrating and transcoding.

In a first aspect of the invention, a video transrating method is disclosed. In one embodiment, the method comprises: (1) receiving an input compressed video bitstream having a first format and having a first bitrate, (2) parsing the input compressed video bitstream to generate a pass-through syntax bitstream, (3) decompressing the input compressed video bitstream to produce an intermediate format video signal, (4) processing the intermediate format video signal, and (5) recompressing the intermediate format video signal to produce an output compressed video bitstream having a second format and having a second bitrate. In one variant, the recompressing is responsive to an information in the pass-through syntax bitstream and the intermediate format video signal comprises a plurality of decoded macroblocks and mode refinement information for each of the plurality of decoded macroblocks.

In a second aspect of the invention, a video transcoding apparatus is disclosed. In one embodiment, the apparatus comprises: a processor; a data bus; and a computer-readable memory. The processor is configured to: (1) receive an input compressed video bitstream having a first format and having a first bitrate; (2) parse the input compressed video bitstream to generate a second bitstream; (3) decompress the input compressed video bitstream to produce an intermediate format video signal; (4) process the intermediate format video signal; (5) compress the intermediate format video signal to produce an output compressed video bitstream having a second format and having a second bitrate, said compression responsive at least to information in said second bitstream; said second bitrate responsive to the said first bitrate and a target transrating bitrate.

In one variant, the intermediate format video signal comprises a plurality of decoded macroblocks and mode information for each of the plurality of decoded macroblocks. In another variant, the mode information comprises intra encoding modes for at least some of the plurality of decoded macroblocks. In a further variant, the compressing preserves an encoding mode of substantially all macroblocks in the input compressed video bitstream. In still another variant, the decompressing is performed without performing a deblocking operation on any macroblock in the input compressed video bitstream. In yet another variant, the compressing is performed without performing a deblocking operation on any macroblock in the output compressed video bitstream.

In a third aspect of the invention, a video transrating method is disclosed. In one embodiment, the method comprises: decoding an input video bitstream to generate a first residual signal having a first temporal location; generating a second residual signal responsive to the first residual signal and a value of a first intermediate signal having a temporal location earlier in time than the first temporal location; requantizing and retransforming the second residual signal to form a second intermediate signal; filtering the second intermediate signal to generate a third intermediate signal; and reconstructing and motion compensating the third intermediate signal to re-generate a value of the first intermediate signal corresponding to the first temporal location.

In one variant, said reconstructing is responsive to mode refinement information extracted from the input video bitstream. In another variant, said motion compensating is responsive to an intra-predicted signal generated from said second intermediate signal.

In a fourth aspect, a video transrating method is disclosed. In one embodiment, the method comprises: (1) decoding, dequantizing, detransforming an input video bitstream to generate a first residual signal; (2) generating a second residual signal responsive to the first residual signal and a first reconstructed intermediate signal; (3) requantizing and transforming the second residual signal to a second reconstructed intermediate signal; (4) filtering the second reconstructed intermediate signal to generate a third intermediate signal; and (5) reconstructing and motion compensating the third intermediate signal to generate the first reconstructed intermediate signal. In one variant, the aforementioned decoding comprises an entropy decoding.

In another embodiment, the method comprises: providing a video bitstream having a first bitrate associated therewith; processing said video bitstream utilizing temporal and spatial correlation; and generating an output bitstream having a second bitrate different from the said first bitrate. The processing of said video bitstream utilizing temporal and spatial correlation decodes a plurality of macroblocks comprising the video bitstream to a partially decoded intermediate format.

In one variant, the method further comprises: extracting a plurality of header bits from the video bitstream; and inserting the plurality of header bits in the output bitstream. In another variant, the partially decoded intermediate format is calculated without performing motion compensation on the plurality of macroblocks.

In a fifth aspect, a video transrating apparatus is disclosed. In one embodiment, the apparatus comprises: (1) a decoding module for decoding an input video bitstream to produce a decoded bitstream; (2) dequantizing and detransforming the decoded bitstream to generate a first residual signal; (3) a residual signal generation module for generating a second residual signal responsive to the first residual signal and a first reconstructed intermediate signal; (4) a requantizing module for requantizing the second residual signal to a second reconstructed intermediate signal; (5) a filtering module for filtering the second reconstructed intermediate signal to generate a third intermediate signal; and (6) a reconstructing module for reconstructing and a motion compensation module for motion compensating the third intermediate signal to generate the first reconstructed intermediate signal. In one variant, the aforementioned decoding comprises an entropy decoding.

In a sixth aspect of the invention, a video processor is disclosed. In one embodiment, the video processor comprises a digital processor such as a DSP or microprocessor having one or more video transcoding and/or transrating algorithms running thereon in the form of computer code.

These and other features, aspects, and advantages of the present invention will be better understood with reference to the following drawings, description and claims.

### BRIEF DESCRIPTION OF THE DRAWINGS

FIG. 1 is a block diagram showing an exemplary transrating system, in accordance with an embodiment of the present invention.

FIG. 2 is a block diagram showing an exemplary transrating system comprising an encoder and a decoder, in accordance with an embodiment of the present invention.

FIG. 3 is a block diagram showing an exemplary transrating system comprising an H.264 decoder and an H.264 encoder, in accordance with an embodiment of the present invention.

FIG. 4 is a block diagram showing an exemplary transrating system without motion estimation, intra decisions, and mode decision, in accordance with an embodiment of the present invention.

FIG. 5 is a block diagram showing an exemplary transrating system without motion estimation, intra decisions, mode decision, and deblocking, in accordance with an embodiment of the present invention.

FIG. 6 is a flowchart showing steps of a method of performing transrating in accordance with an embodiment of the present invention.

FIG. 7 is a block diagram showing an exemplary transrating system sharing implementation blocks between decompression and recompression, in accordance with an embodiment of the present invention.

FIG. 8 is a block diagram showing another exemplary transrating system sharing implementation blocks between decompression and recompression, in accordance with an embodiment of the present invention.

FIG. 9 is a block diagram of an exemplary implementation of an open loop transrating system in accordance with an embodiment of the present invention.

FIG. 10 is a block diagram of an exemplary implementation of a transrating apparatus in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

As used herein, “video bitstream” refers without limitation to a digital format representation of a video signal that may include related or unrelated audio and data signals.

As used herein, “transrating” refers without limitation to the process of bit-rate transformation. It changes the input bit-rate to a new bit-rate which can be constant or variable according to a function of time or satisfying a certain criteria. The new bitrate can be user-defined, or automatically determined by a computational process such as statistical multiplexing or rate control.

As used herein, “transcoding” refers without limitation to the conversion of a video bitstream (including audio, video and ancillary data such as closed captioning, user data and teletext data) from one coded representation to another coded representation. The conversion may change one or more attributes of the multimedia stream such as the bitrate, resolution, frame rate, color space representation, and other well-known attributes.

As used herein, the term macroblock (MB) refers without limitation to a two dimensional subset of pixels representing a video signal. A macroblock may or may not be comprised of contiguous pixels from the video and may or may not include equal number of lines and samples per line. A preferred embodiment of a macroblock comprises an area 16 lines wide and 16 samples per line.

### Transrating Overview

In one salient aspect, the present invention takes advantage of temporal and spatial correlation of video signals to reduce complexity of transrating a video bitstream. The video signal underlying a video bitstream has the notion of time sequenced video frames. For example, National Television System Committee (NTSC) signal broadcast in analog television networks in the United States is made up of 29.97=30/1.001 frames per second video signal. Furthermore, each video picture is made up of two-dimensional arrays of pixels. In one embodiment, the present invention contemplates processing video bitstreams representing smaller units of a frame; these smaller units are referred to herein as macroblocks (MB), although other nomenclature may be used. An MB may comprise for example a rectangular area of 16×16 pixels, each pixel being represented by a value or a set of values. For instance, a pixel may have a luminance value and two color values (Cb and Cr). Other possible implementations are possible and will be recognized by those of ordinary skill in the video processing field given the present disclosure.

In a video bitstream representing a video signal in a sequence that comprises video pictures, grouped together in sequence of MBs, the present invention applies transrating techniques to exploit correlations among MBs that are spatially near to each other, or to video pictures that are temporally near to each other. In particular, the present invention in one embodiment uses MB-level encoding decisions from spatially nearby MBs, and picture-level encoding decisions from temporal neighbors to trade off complexity of transrating.

The present invention further exploits characteristics of many advanced video encoders, whose processing techniques include both a “lossless” part—such as run-length encoding or filtering, and a “lossy” part such as quantization and rounding. The present invention may handle the lossless computational steps and the lossy computational steps separately, exploiting them for inter alia trading off complexity and quality of the resulting transrated video.

### Exemplary Apparatus

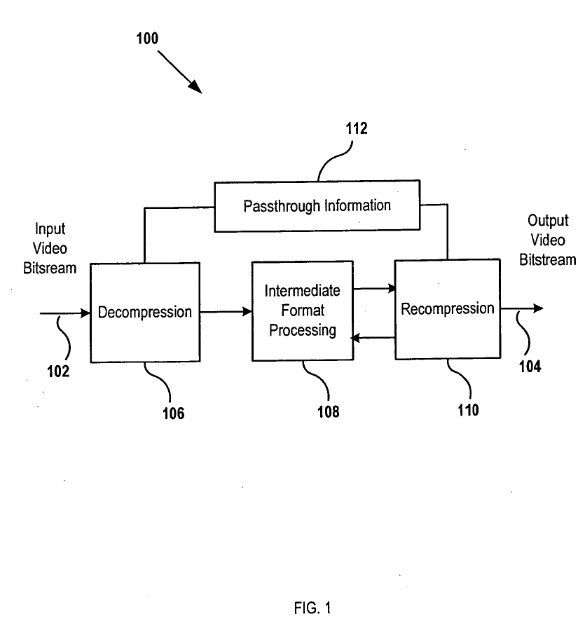

FIG. 1 shows one embodiment of a generalized transcoding system 100 according to the invention, where an input video bitstream 102 with a first bitrate is transcoded into an output video bitstream 104 with a second bitrate. The input video bitstream 102 may be, for example, conformant to the H.264 syntax or the VC-1 syntax. Similarly, the output video bitstream 104 may conform to a video syntax. Generally, when the syntax used by the input video bitstream 102 and the output video bitstream 104 are same, then the transcoding operation only performing transrating function, as defined above. The input video bitstream 102 is converted into an intermediate format using decompression 106. In various implementations, the decompression operation 106 may include varying degrees of processing, depending on the tradeoff between qualities and processing complexity desired. In one embodiment, this information is hard-coded into the apparatus, although other approaches may be used as will be recognized by those of ordinary skill. The intermediate format may for example be uncompressed video, or video arranged as macroblocks that have been decoded through a decoder (such as an entropy decoder of the type well known in the video processing arts). Some information from the input video bitstream may be parsed and extracted in module 112 to be copied from the input to the output video bitstream. This information, referred to as “pass-through information” herein, may contain for example syntactical elements such as header syntax, user data that is not being transrated, and/or system information (SI) tables, etc. This information may further include additional spatial or temporal information from the input video bitstream 102. The intermediate format signal may be further processed to facilitate transcoding (or transrating) as further described below. The processed signal is then compressed (also called recompressed because the input video signal 102 was in compressed form) to produce the output video bitstream 104. The recompression also uses the information parsed and extracted in module 112.

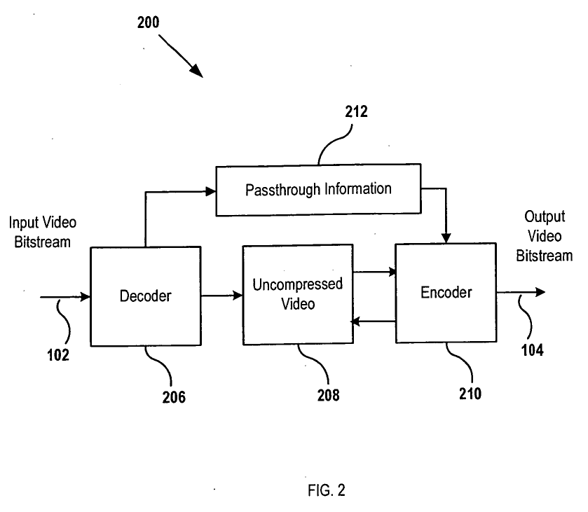

FIG. 2 shows an exemplary transcoding system 200 showing a decoder module 206 that may receive an input video bitstream 102. The system 200 decodes input video bitstream 102 in a decoder module 206 to produce uncompressed digital video. The uncompressed digital video, which is in the intermediate video format for the system 200, may be processed in the uncompressed video module 208 to aid the transrating operation. The intermediate format processing may include operations such as e.g., filtering the uncompressed video to preserve visual quality at the output of the transrating. In one embodiment, the intermediate format processing includes removing redundancies in the uncompressed video (e.g., 3:2 pull-down and fade detection), or generating information such as scene changes that may be useful for encoding performed on in the encoder 210. In the illustrated system 200, the pass-through information 212 may comprise for example of user data and various header fields such as a sequence-level header, or a picture-level header or sub-picture level header.

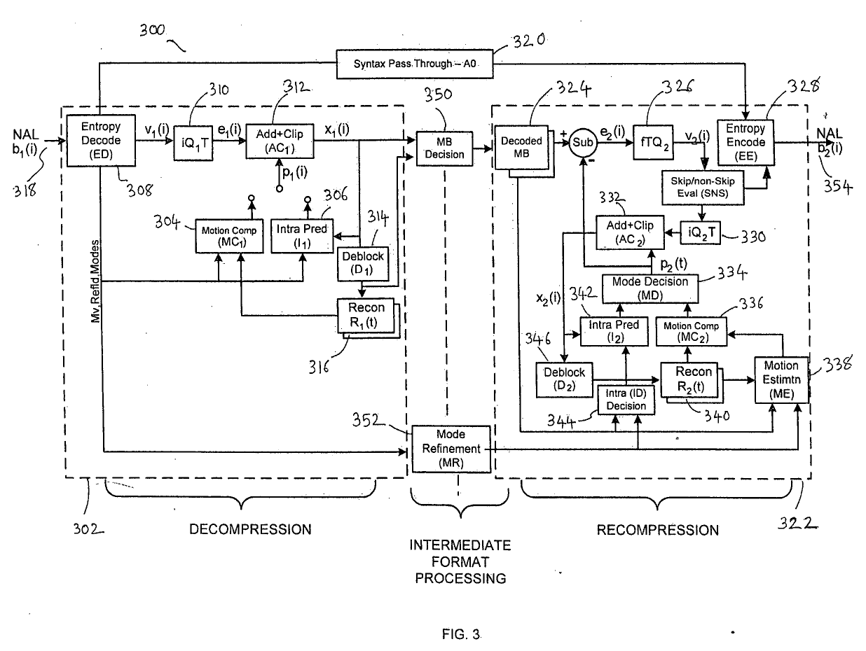

FIG. 3 shows an exemplary embodiment 300 of the transrating system 200 for transrating a video bitstream compliant with an advanced video codec specification (such as H.264 or VC-1, although the invention is in no way limited to these “advanced” codecs). The transrater 300 includes a decompression module 302, and intermediate format processing module 350, and a recompression module 322, with the syntax pass-through operation performed in module 320. In one exemplary embodiment, the decompression sub-system 302 includes an entropy decoder 318 that performs lossless decoding of input bitstream to an output bitstream, denoted for a given MB as v₁(i) in FIG. 3. The index “i” represents a sequence number of the picture being processed from the input video bitstream. The output of the entropy decoder 308 may be used by the inverse quantizer and inverse transformer 310 to produce a residual signal e₁(i) and the motion compensation module 304. The output of the entropy decoder 308 may also be used by the syntax pass-through module 320, to produce pass-through bits that are communicated to the recompression module 322. The add/clip module 312 may process output signal e₁(i) from the inverse quantizer and inverse transformer 310 and a predicted MB signal p₁(i), to produce an estimate of the reconstructed undeblocked uncompressed video pixel values x₁(i).

The intermediate format processing in the illustrated transrater 300 comprises a MB decision module 350. For processing in module 350, the transrater 300 may have most or substantially all pixels of a picture available in decompressed form. In one embodiment, the transrater 300 may make decisions regarding how to code each MB by processing the decompressed video. In another embodiment, the transrater 300 may preserve the MB modes as encoded in the incoming video bitstream.

In yet another embodiment, the transrater 300 may change MB decisions to help maintain video quality at the output of the transrater 300. This change in MB decisions may also be responsive to the target output bitrate. For example, to reduce number of bits generated by encoding a MB in the output video bitstream, the transrater 300 may favor encoding more MBs as inter-MBs instead of intra-MBs.

The recompression module 322 re-encodes the uncompressed video back to a compressed video bitstream by performing a recompression operation. The recompression may be performed such that the output video bitstream 354 comprises format compliant to an advanced video encoding standard such as e.g., H.264/MPEG-4 or VC-1. Because the input video bitstream is converted into an intermediate uncompressed video format, transrater 300 may advantageously be used to change the bitstream standard also. For example, input video bitstream 102 may be in H.264 compression format and the output video bitstream 104 may be in the VC-1 compression format, or vice-a-versa. The recompression module 322 includes a module 324 for processing decoded macroblocks, and a forward quantizer and forward transformer 326 that quantizes and transforms the residual output e₂(i) generated from subtraction of the predicted signal p₂(i) from the output of the decoded MB module 324. Another forward quantizer and forward transformer module 326 is used to quantize and transform coded residual signal for the decoder loop insider the recompression module 322. The decoder loop also includes an add/clip module 332, and a deblocking module 346 that provides input to the reconstruction module 340. The output predicted pictures from the reconstruction module 340 are used by a motion estimation module 338. The motion estimation module 338 receives motion vector information from the entropy decoder 308 (i.e., via the mode refinement module 352) to help speed up estimation of accurate motion vectors. A motion compensation module 336 is used to perform motion compensation in the recompression module 322. The motion compensation module 322 can be functionally different from the motion compensation module 304. The latter does a single motion compensation for a given mode specified in the compressed bitstream. In 322, the motion compensation module does motion compensation for one or more modes and passes on the results to the mode decision engine 334 to decide which mode to choose among the many tried. The output of motion compensation 322 is fed into a mode decision module 334, along with the output of an intra prediction module 342. The mode decision module 334, in turn drives the inputs to the add/clip module 332.

In FIG. 3, functional blocks useful for the description of the present invention are shown. Practitioners of ordinary skill in the art will recognize that the decompression sub-system 302 is an exemplary H.264 decoder, and embodiments may contain additional functional blocks connected in a variety of different ways to produce uncompressed digital video from an H.264 video bitstream. In addition to performing decompression, the embodiment of the apparatus 300 of FIG. 3 also extracts pass-through information (e.g., syntax) in a functional block 320. The system represented in FIG. 3 is called “A0” subsequently herein.

While conceptually easy to understand, the system shown in FIG. 3 may represent a choice of transrating operation; e.g., one that may be very good in quality, but may be computationally “expensive” due to the need of implementing the logic, memory and bus bandwidth for a complete decoding from input video bitstream to a uncompressed video format, followed by a complete encoding operation to convert from the uncompressed video format to transrated compressed video format. The compression module 322 includes a motion estimation module 338, which may be computationally expensive. Besides, the motion compensation 336, intra decision 344 and mode decision 334 modules are expensive in computation, memory and bus bandwidth. The A0 syntax pass-through is also configured to advantageously save some computations by enabling reuse of some syntactical elements from the input video bitstream in the output video bitstream. For example, for an H.264 input bitstream, information regarding sequence headers, picture headers, and/or slice headers may be optionally included in the pass-through data. In the embodiment shown in FIG. 3, the transrating system 300 may also preserve the picture “type” of each video frame (e.g., an I picture is transrated to an I picture, a B picture is transrated to a B picture, and so on). This result in preservation of video quality in the transrated output video bitstream, and save computations to calculate picture time in the compression process 322. The system 300 proves advantageous because all motion vectors, reference indices and mode decisions are recomputed at the encoder stage 322. Because uncompressed video is available in the intermediate format, the system 300 may also be used for changing picture size (spatial resolution), picture rate (temporal resolution), color format, compression standard, and many other transcoding attributes.

When the transcoding system 100 is implemented in hardware, firmware or software, or a combination thereof, a designer may make several tradeoffs regarding timing of circuits used, bus bandwidth, available data and instruction storage memory, complexity of software instructions, and so on. When processing high pixel resolution data, one salient consideration for implementation is the amount of bus bandwidth required for reading the input bitstream, reconstructing the pixels, performing motion search, and storing intermediate results. In particular, the intermediate format processing module 108 (FIG. 1) processes video in groups of pixels (e.g., one MB at a time) that requires reading from, and writing to memory pixel values of adjoining MBs (e.g., for operations such as motion vector (MV) prediction and deblocking). In one aspect, the present invention describes methods of reducing the bus bandwidth required for transrating by replacing exact transrating calculations with approximations, while maintaining visual quality of the transrated output video signal. One feature of the illustrated embodiment of the invention is therefore to give similar video quality as the decode/encode combination, while minimizing bus bandwidth, logic and memory utilization and requirements.

### Alternate Embodiment (A1)

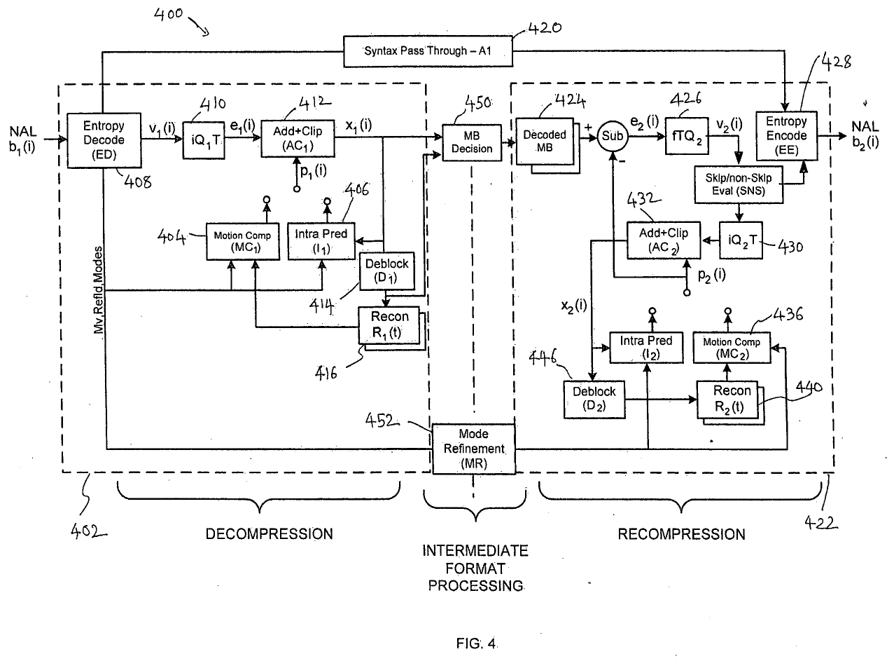

FIG. 4 shows another embodiment 400 (herein referred to as A1 transrater) of a transrating apparatus in accordance with the present invention. In this embodiment 400, the encoding and decoding processing modules are simplified to eliminate the intra decision, motion estimation and mode decision components of the encoder (see FIG. 3) which are computationally intensive. The motion compensator is also greatly simplified. The decompression subsystem 402 comprises a motion compensation module 404 which gets its input from an entropy decode module 408 that produces motion vectors and MB modes. Intra-prediction is performed in the intra-prediction module 406. The output v₁(i) of entropy decode module 408 is input to an inverse quantizer and inverse transformer module 410 that produces a residual signal e₁(i). The residual signal e₁(i) is processed by an add/clip module 412 to produce intermediate video data x₁(i) used by a deblock module D₁ 414 and the intra-prediction module 406. The decompression subsystem 402 further comprises a reconstruction module 416. The intermediate format processing is performed in a MB decision module 450, further described below.

The compression subsystem 422 of the illustrated embodiment comprises a decoded MB processing module 412 that receives decisions from MB decision module 450 and produces decoded MB pixel values. A residual signal, e₂(i) is generated by subtracting output of the decoded MB processing module 412 and predicted pixel values p₂(i). The residual signal e₂(i) is then be quantized and transformed in module 426 to produce signal v₂(i) used for entropy encoding to generate the output video bitstream 104. A quantizer and transformer module 430 is used to re-quantize pixel values of signal v₂(i). The output of the quantizer and transformer module 430 is then processed through an add/clip module 432 to produce a signal x₂(i) that is input to a deblocking module 446. The reconstruction module 440 is used to reconstruct pixels in uncompressed video format from output of the deblocking module 446. The uncompressed video is processed in a motion compensation module MC2 436.

As previously noted, the apparatus 400 of FIG. 4 does not have an intra decision, mode decision, and motion estimation module. This approach advantageously saves both computational complexity and bus bandwidth required to process video signals by eliminating the need to calculate mode decisions, motion vectors, and reference indices when transferring video in intermediate format from the decoder to the encoder stage. This saves considerable amounts of logic, memory and bus bandwidth, which would otherwise be required to support these functions. Experimental data generated by the inventor(s) hereof shows that the A1 transrater 400 preserves video quality compared to A0 at the output for up to as much as a 30% reduction in bitrate at the output (i.e., quality can be substantially maintained with up to 30% reduction in bitrate).

The intra decision module 344 and motion estimation module 338 and mode decision module 334 used in the transrater 300 of FIG. 3 are not needed in the transrater 400 of FIG. 4. Besides, the motion compensation module 436 is vastly simpler in 400 when compared to module 336 in 300. The transrater 400 advantageously offers several implementation efficiencies without compromising the visual quality of resulting transrater bitstream. For example, the absence of the motion estimation module 338 can provide significantly reduced complexity of implementation, including reduced bus bandwidth requirements due to elimination of the motion vector search.

Table 1 shows exemplary pass-through syntax that may be processed in the module 400:

TABLE 1
A1 Passthrough Syntax

| | |
|---|---|
| 1 | Picture Type |
| 2 | SPS and PPS syntax |
| 3 | Slice header and slice data syntax |
| 4 | MB layer syntax |
| 5 | MB prediction syntax |
| 6 | Deblock parameters |
| | Mode decisions: |
| | Picture level field/frame decisions |
| | Inter/intra decisions |
| | Intra 16 × 16, 8 × 8, 4 × 4 modes |
| | Inter partition type |
| | Motion vector and reference indices |
| 7 | Mode refinement parameters |

### Exemplary Bandwidth Calculation

If the video bitstream processed by a transrater represents interlaced high definition video at 1920 pixels×1080 lines resolution at 30 frames per second, the bus bandwidth required for data read/writes may include for example the values shown in Table 2 below:

TABLE 2

| | Bandwidth |
|---|---|
| Item | (bytes/second) |
| Writing a reference picture out: 1920 | 94,003,200 |
| wide × 1088 high (corresponding to 68 MB | |
| rows) × 1.5 bytes per pixels (luma + | |
| one-fourth chroma components) × 30 frames/sec | |
| Reading a reference in: 16 Partitions per | 775,526,400 |
| MB × (9 × 9Y + 2 × 3 × 3Cb/Cr) support × | |
| 8160 MBs/frame × 30 frames/sec × 2 refs | |
| Coloc out: 8160 MBs × 160 B × 30 frames/sec | 39,168,000 |
| Coloc in: 8160 MBs × 160 B × 30 frames/sec | 39,168,000 |
| Intra Pred: 2 in/out × 1920 wide × 2 color × | 230,400 B/sec |
| 30 frames/sec | |
| NeighborHood: 2 in/out × 34 B (Block | 16,646,400 B/sec |
| Info + Cb/CrCoefs) × 8160 MBs/frame × | |
| 30 frames/sec | |
| Total bandwidth = 2 (dec + enc) × | 1,929,484,800 |
| 964,742,400 B/sec | |

As shown in FIG. 4 and described above, the transrater A1 400 may in one embodiment use the deblocking function four times—(1) the original encoder, (2) the decoder of the transrater, (3) the partial encoder of the transrater, and (4) the final decoder (such as a set-top box) at a consumer's premises in a digital video distribution network. This design may be simplified, however, by removing the deblocking at the steps (2) and (3), but passing on the deblocking information for use in the final decoder in step (4) above. This simplification can potentially cause minor drifts. However, test implementations produced by the inventor(s) hereof indicate that removing the deblocking from architecture A1 simplifies the design with minor picture quality losses for I pictures.

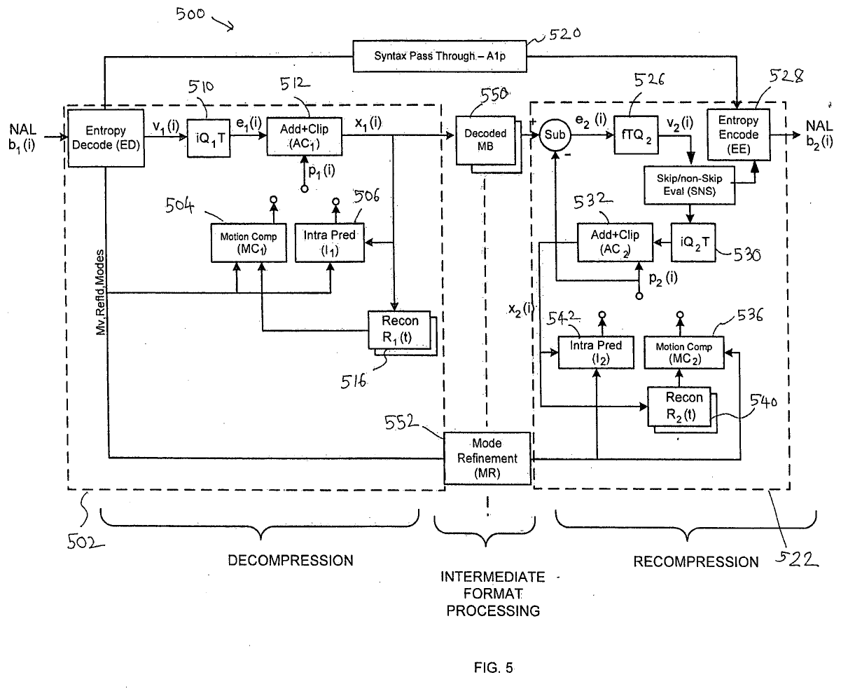

FIG. 5 is a block diagram showing an exemplary embodiment of a transrating system, hereinafter referred to as the A1p transrater 500. The decompression module 502 comprises a motion compensation module 504, an intra-prediction module 506, an entropy decoder, an inverse quantizer and inverse transformer 510, an add/clip module 512, and a reconstruction module 516. The intermediate format processing module 552 includes a processing module for decoded MBs 550, and a mode refinement module 552. The illustrated embodiment of the compression module 522 comprises a quantizer and transformer 526, an entropy encoder 528, an inverse quantizer and inverse transformer module 530, an add/clip module 532, a motion compensation module 536, an intra prediction module 542, and a reconstruction module 540.

Advantages of the A1p 500 embodiment over the A1 400 embodiment include: (i) less logic due to the absence of deblocking at the decoder and partial encoder stages, (ii) less bus bandwidth out of the device to external memory (e.g., by approximately 62 megabytes per second in one implementation), (iii) less bus bandwidth into the device from external memory (e.g., by approximately 62 megabytes per second), and (iv) less use of internal memory (e.g., by approximately 2 megabytes).

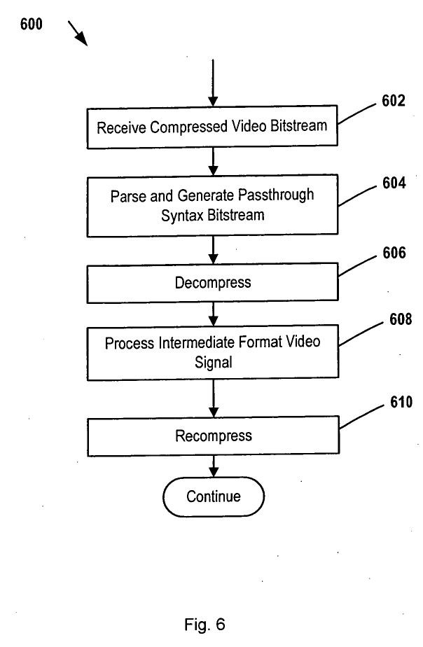

FIG. 6 shows steps of one embodiment of the generalized method 600 of transrating video bitstreams in accordance with the present invention. In step 602, the transrater receives a compressed video bitstream. The compressed video bitstream may be received from a network, a recording device, or any other source. Upon reception, the transrater parses the received bitstream, and generates pass-through syntax bitstream in step 604. The parsing action depends on the syntax of the received video bitstream. For example, if the received video bitstream is encrypted, the transrater performs a decryption operation to generate a decrypted video bitstream, and performs the subsequent processing in decrypted state. In another embodiment, the input video bitstream is received in a network abstraction layer (NAL) format, and is converted into an intermediate format suitable for processing by the transrater. The transrater performs the decompression function in step 606. The decompression operation in step 606 outputs video signals in an intermediate format. For example, in one embodiment, the decompression step 606 produces uncompressed digital video signal. In another embodiment, the decompression step 606 produces a series of partially decoded MBs. The transrater processes the video signal in the intermediate format in step 608 to produce a bitstream useful for recompression in step 610. The transrater makes the output of the parsing step 604 available to the recompression performed in step 610. In one embodiment, the processing step 608 includes color space conversion. In another embodiment, the transrater performs filtering to condition the video to make it easier for recompression at a lower rate in step 610 without losing visual quality in the recompressed signal. In yet another embodiment, the transrater changes the resolution of the intermediate signal (e.g., high definition or HD to standard definition or SD), or performs rate shaping operations.

### Mathematical Foundation For A0 and A1

Using the notations in FIG. 3, let v₁(i) be the input to the transrater after entropy decode for picture i for any MB. The decoder may be mathematically represented by the following equations:

e₁(i)=iQ₁T(v₁(i)) (1)

x₁(i)=e₁(i)+p₁(i)=iQ₁T(v₁(i))+p₁(i) (2)

Here, x₁(i) is the pre-deblocked reconstructed picture for the decoder, p₁(i) is the intra or inter-prediction, and iQ₁T(·) is the inverse quantization and transform with quantization step Q₁. The prediction p₁(i) is given by:

$${p}_{1} ( i ) = \{ \begin{matrix}{I}_{1} ( {x}_{1} ( i ) ) & for intra \\ {MC}_{1} ( {D}_{1} ( {x}_{1} ( i - j ) ) ) & for inter ,\end{matrix} \qquad ( 3 )$$

where I₁(·) is the intra-prediction operation, D₁(·) is the deblocking operation, and MC₁(·) is the motion compensated prediction operation. Intra-prediction I₁(·) may require un-deblocked pixels from the current reconstructed picture x₁(i), whereas the inter-prediction MC₁(·) may require pixels from the deblocked stored reconstructed picture x₁(i−j), j≠0.

The recompression operation may be mathematically represented by the following equations:

e₂(i)=x₁(i)−p₂(i)=e₁(i)+p₁(i)−p₂(i) (4)

v₂(i)=fTQ₂(e₂(i))=fTQ₂(iQ₁T(v₁(i))+p₁(i)−p₂(i)) (5)

x₂(i)=iQ₂T(v₂(i))+p₂(i)=iQ₂T(fTQ₂(iQ₁T(v₁(i))+p₁(i)−p₂(i)))+p₂(i) (6)

For frame i in a given MB, x₂(i) is the pre-deblocked reconstructed picture for the encoder, v₂(i) is output of the transcoder before entropy encoder, and p₂(i) is the intra- or inter-prediction:

$${p}_{2} ( i ) = \{ \begin{matrix}{I}_{2} ( {x}_{2} ( i ) ) & for intra \\ {MC}_{2} ( {D}_{2} ( {x}_{2} ( i - j ) ) ) & for inter ,\end{matrix} \qquad ( 7 )$$

where iQ₂T(·) and fTQ₂(·) are the inverse and forward transforms with quantization Q₂, I₂(·) is the intra-prediction, D₂(·) is the deblock, and MC₂(·) is the motion compensated prediction function for the encoder stage. Using equations (4) through (6), equation (5) may be simplified to:

$${v}_{2} ( i ) = {fTQ}_{2} ( \begin{matrix}{iQ}_{1} T ( {v}_{1} ( i ) ) + \\ \{ \begin{matrix}{I}_{1} ( {x}_{1} ( i ) ) - {I}_{2} ( {x}_{2} ( i ) ) & for intra \\ {MC}_{1} ( {D}_{1} ( {x}_{1} ( i - j ) ) ) - {MC}_{2} ( {D}_{2} ( {x}_{2} ( i - j ) ) ) & for inter\end{matrix}\end{matrix} ) , \qquad ( 8 )$$

where j≠0. Equation (8) may be considered to be a general expression for the full decode and full encode as embodied in the transrater A0 300 in FIG. 3. As described above, in FIG. 4, the transrater A1 400 may share the input prediction parameters such as intra- and inter- modes, motion vectors, and reference indices from decompression module 402 to recompression module 422. Thus, the prediction functions I₁(·) and MC₁(·) may be same as I₂(·) and MC₂(·) respectively, i.e.;

I₁(·)=I₂(·), and MC₁(·)=MC₂(·). (9)

Replacing this, in Equation (8), we get:

$${v}_{2} ( i ) = {fTQ}_{2} ( \begin{matrix}{iQ}_{1} T ( {v}_{1} ( i ) ) + \\ \{ \begin{matrix}{I}_{1} ( {x}_{1} ( i ) ) - {I}_{1} ( {x}_{2} ( i ) ) & for intra \\ {MC}_{1} ( {D}_{1} ( {x}_{1} ( i - j ) ) ) - {MC}_{1} ( {D}_{2} ( {x}_{2} ( i - j ) ) ) & for inter\end{matrix}\end{matrix} ) , \qquad ( 10 )$$

From Equation (4), we get the following approximate equation for the transrating architecture A2:

$${v}_{2} ( i ) \approx {fTQ}_{2} ( \begin{matrix} {iQ}_{1} T ( {v}_{1} ( i ) ) + \\ \{ \begin{matrix}{I}_{1} ( {x}_{1} ( i ) - {x}_{2} ( i ) ) & for intra \\ {MC}_{1} ( {D}_{1} ( {x}_{1} ( i - j ) ) - {D}_{2} ( {x}_{2} ( i - j ) ) ) & for inter\end{matrix}\end{matrix} ) . \qquad ( 11 )$$

Equation (4) indicates that the intra-prediction uses the difference of the current un-deblocked reconstructed picture x₁(i)−x₂(i), whereas the motion compensated prediction uses the difference of the deblocked reference pictures D₁(x₁(i−j))−D₂(x₂(i−j)). If deblock is not there, i.e., D₁(·)=D₂(·)=identity function, then inter-prediction also uses the difference of the reference pictures x₁(i−j))−x₂(i−j), for j≠0. However, if deblock is present, the inter-prediction can be modified as:

D₁(x₁(i−j))−D₂(x₂(i−j))˜XF(x₁(i−j)−x₂(i−j)), (12)

where XF(·) is the new X-Filter used instead of the deblocking filter defined in the H.264 standard. Thus, the new equation for the output v₂ is:

$${v}_{2} ( i ) \approx {fTQ}_{2} ( \begin{matrix}{iQ}_{1} T ( {v}_{1} ( i ) ) + \\ \{ \begin{matrix}{I}_{1} ( {x}_{1} ( i ) - {x}_{2} ( i ) ) & for intra \\ {MC}_{1} ( XF ( {x}_{1} ( i - j ) - {x}_{2} ( i - j ) ) ) & for inter\end{matrix}\end{matrix} ) . \qquad ( 13 )$$

Following Equation (13), instead of the individual reconstructed pictures, we use the difference of the reconstructed pictures.

For architecture A1p referenced above, the deblock functions D₁(·) and D₂(·) are removed from Equation (8) as:

$${v}_{2} ( i ) = {fTQ}_{2} ( \begin{matrix}{iQ}_{1} T ( {v}_{1} ( i ) ) + \\ \{ \begin{matrix}{I}_{1} ( {x}_{1} ( i ) ) - {I}_{1} ( {x}_{2} ( i ) ) & for intra \\ {MC}_{1} ( {x}_{1} ( i - j ) ) - {MC}_{1} ( {x}_{2} ( i - j ) ) & for inter\end{matrix}\end{matrix} ) . \qquad ( 14 )$$

This equation can be further approximated as in Equation (13) as:

$${v}_{2} ( i ) \approx {fTQ}_{2} ( \begin{matrix}{iQ}_{1} T ( {v}_{1} ( i ) ) + \\ \{ \begin{matrix}{I}_{1} ( {x}_{1} ( i ) - {x}_{2} ( i ) ) & for intra \\ {MC}_{1} ( {x}_{1} ( i - j ) - {x}_{2} ( i - j ) ) & for inter\end{matrix}\end{matrix} ) . \qquad ( 15 )$$

The algorithm embodiment A2 may in certain cases have several advantages over the embodiments A1 400 and A1p. 500 previously described. These may include:
1. Less logic—due to simplifications such as elimination of motion estimation, mode decision and intra decision.
2. Less Bandwidth Out—pixel fetching/writing intermediate results such as half-pel or quarter-pel accuracy motion estimations may not be needed, thereby saving write-out operations.
3. Less Bandwidth In—fetching of reference frame data for motion estimation is not needed. Similarly, fetching intermediate results from memory may not be needed for motion estimation purposes. In the A1p transrater 500, deblocking is eliminated, thereby ameliorating the need to fetch pixel values from surrounding MBs for deblocking filtering calculations.
4. Less use of Internal Memory—Due to fewer processing modules, each of which requires local memory, we have much less use of internal memory. Deblocking, for example, requires nearly 2 megabytes of internal memory.

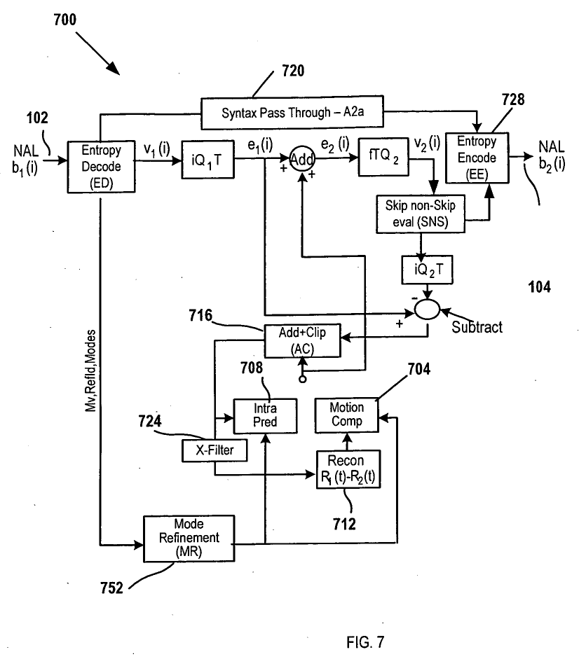

FIG. 7 shows yet another embodiment of a transrater A2a 700 in accordance with the present invention. Recognizing that Equation (13) above offers an opportunity to further reduce the bandwidth required to implement a transrater, the transrater A2a 700 can be implemented by eliminating a motion compensation module (e.g., from the previously discussed embodiments of FIGS. 4 through 6). The transrater 700 of FIG. 7 may be implemented using, for example, a single motion compensation module 704 and a single intra-prediction module 708. The syntax pass-through module 720 may be configured to pass-through header fields, and/or other “overhead” information related to encoding the input video bitstream 102, to the entropy encoder 728 for producing the output bitstream 104. The add/clip module 716 may be adapted to clip values suitable to be input to the X-filter module 724. The X-filter module performs the task described in Equation (12) above (i.e., conditioning the video signal to have fewer visually objectionable artifacts), and may use techniques such as for example finite impulse response or other types of filtering. The reconstruction module 712 reconstructs the differential signal, as shown in Equation (15) above. Furthermore, the transrater A2a 700 may also at least partly integrate the decompression and recompression subsystems by combining several functions into a single module (e.g., motion compensation module 704). The amount of bandwidth needed to implement such a system may significantly be reduced by reducing number of reconstruction and compensation modules in the transrater implementation. For example, in the transrater apparatus embodiment 700 of FIG. 7, the bandwidth required can be calculated as follows:

The bandwidth numbers for 1080i HD video at 30 frames/sec are:

1. Reference out: 1920 wide×1088 high×1.5 color×30 frames/sec=94,003,200 B/sec.

2. Reference in: 16 Parts×(9×9Y+2×3×3Cb/Cr) support×8160 MBs/frame×30 frames/sec×2 refs=775,526,400 B/sec.

3. Co-located samples out: 8160 MBs×160B×30 frames/sec=39,168,000 B/sec.

4. Co-located in: 8160 MBs×160B×30 frames/sec=39,168,000 B/sec.

5. Intra Pred: 2 in/out×1920 wide×2 color×30 frames/sec=230,400 B/sec.

Total bandwidth=948,096,000 B/sec.

Compared to the architectures A1 or A1p, architectures A2a or A2b each use one-half the bandwidth.

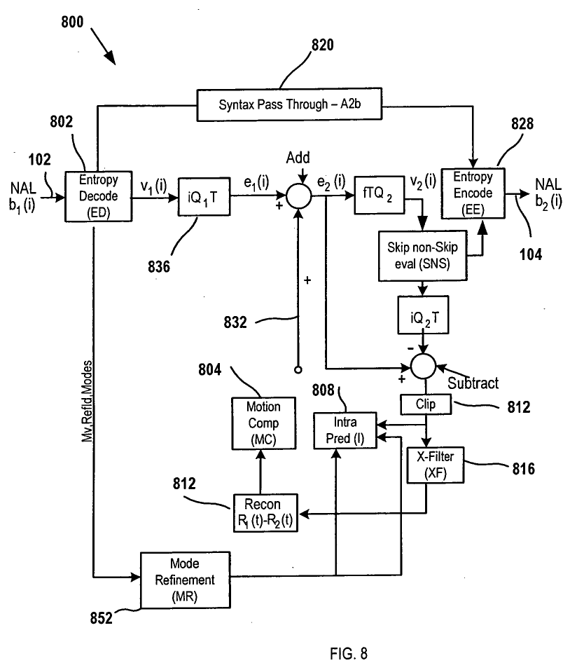

FIG. 8 is a block diagram showing another exemplary transrating system A2b. In this embodiment, functional elements (e.g., various blocks) are shared between the decompression and recompression processes. Similar to FIG. 7, the embodiment of the transrater 800 of FIG. 8 is implemented using a single motion compensation module 804 and a single intra-prediction module 808. The syntax pass-through module 820 may be configured to pass-through header fields, and/or other “overhead” information related to encoding the input video bitstream 102, to the entropy encoder 828 for producing the output bitstream 104. The Add/Clip module is simplified to just a Clip module 812 followed by an X-filter module 816. The X-filter module in this embodiment performs the task described in Equation (12) above (i.e., conditioning the video signal to have fewer visually objectionable artifacts), and may use techniques such as for example finite impulse response or other types of filtering well known to those of ordinary skill in the signal processing arts. The reconstruction module 812 reconstructs the differential signal, as shown in Equation (15) above. Furthermore, the transrater A2b 800 may also at least partly integrate the decompression and recompression subsystems by combining several functions into a single module (e.g., motion compensation module 804). The amount of logic, memory and bus bandwidth needed by architecture A2b in 800 is practically same as architecture A2a in 700. Advantageously, the savings in all three of these parameters are significant compared to architectures A1 and A1p in FIGS. 4 and 5 respectively.

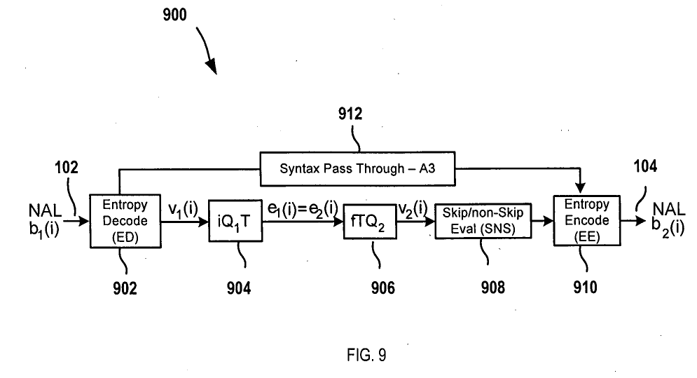

FIG. 9 shows an exemplary open loop embodiment 900 of a transrater according to the invention. The transrater transrates incoming video bitstream 102 to output a video bitstream 104. This algorithm only implements the inverse and forward quantization (elements 904 and 906 of FIG. 9, respectively) without regard for drift caused by transrating errors. The output of the forward quantizer 906 is used as input to the skip/non-skip evaluation module 908, which where decisions regarding skipped MBs are taken. The output is fed into an entropy encoder 910, which also receives syntax passthrough information extracted from the entropy decoder block 902 via the syntax passthrough subsystem 912. Empirical data has shown that while this transrating apparatus can be implemented with very low complexity, the quality of encoded pictures may deteriorate considerably due to the open loop nature of the inverse/forward quantization process.

Returning to equation (1), A3 assumes that for a given picture i, the decoder and encoder stage predictions are the same, i.e., p1(i)=p2(i). Therefore, from equations (1) or (6) we have

v₂(i)≈fTQ₂(iQ₁T(v₁(i))) (16)

Clearly, the assumption is invalid for bit-rate changes beyond a small amount (e.g., less than 5%). Thus, larger bit-rate changes during transrating cause significant drift—that is increasing degradation in video quality in successive video frames, until refreshed by a corrective frame. As will be seen, this algorithm has much less logic and bandwidth requirements than the A2 embodiment described above; practically all of the bandwidth calculations discussed above are eliminated.

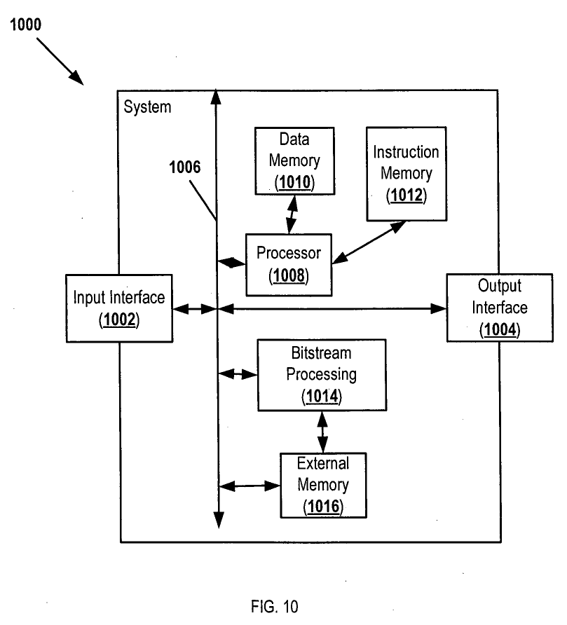

FIG. 10 shows an exemplary system-level apparatus 1000, where one or more of the various methods and transcoding/transrating apparatus of the present invention are implemented, such as by using a combination of hardware, firmware and/or software. This embodiment of the system 1000 comprises an input interface 1002 adapted to receive one or more video bitstreams, and an output interface 1004 adapted to output a one or more transrated output bitstreams. The interfaces 1002 and 1004 may be embodied in the same physical interface (e.g., RJ-45 Ethernet interface, PCI/PIC-x bus, IEEE-Std. 1394 “FireWire”, USB, wireless interface such as PAN, WiFi (IEEE Std. 802.11, WiMAX (IEEE Std. 802.16), etc.). The video bitstream made available from the input interface 1002 may be carried using an internal data bus 1006 to various other implementation modules such as a processor 1008 (e.g., DSP, RISC, CISC, array processor, etc.) having a data memory 1010 an instruction memory 1012, a bitstream processing module 1014, and/or an external memory module 1016 comprising computer-readable memory. In one embodiment, the bitstream processing module 1014 is implemented in a field programmable gate array (FPGA). In another embodiment, the module 1014 (and in fact the entire device 1000) may be implemented in a system-on-chip (SoC) integrated circuit, whether on a single die or multiple die. The device 1000 may also be implemented using board level integrated or discrete components. Any number of other different implementations will be recognized by those of ordinary skill in the hardware/firmware/software design arts, given the present disclosure, all such implementations being within the scope of the claims appended hereto.

In one exemplary software implementation, methods of the present invention are implemented as a computer program that is stored on a computer useable medium, such as a memory card, a digital versatile disk (DVD), a compact disc (CD), USB key, flash memory, optical disk, and so on. The computer readable program, when loaded on a computer or other processing device, implements the transcoding and/or transrating methodologies of the present invention.

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It will also be appreciated that while the above description of the various aspects of the invention are rendered in the context of particular architectures or configurations of hardware, software and/or firmware, these are merely exemplary and for purposes of illustration, and in no way limiting on the various implementations or forms the invention may take. For example, the functions of two or more “blocks” or modules may be integrated or combined, or conversely the functions of a single block or module may be divided into two or more components. Moreover, it will be recognized that certain of the functions of each configuration may be optional (or may be substituted for by other processes or functions) depending on the particular application.

It should be understood, of course, that the foregoing relates to exemplary embodiments of the invention and that modifications may be made without departing from the spirit and scope of the invention as set forth in the following claims.

What is claimed:

1. A video transcoding method, comprising:
receiving an input compressed video bitstream having a first format and having a first bitrate;
parsing the input compressed video bitstream to generate a second bitstream;
decompressing the input compressed video bitstream to produce an intermediate format video signal;
processing the intermediate format video signal; and
compressing the intermediate format video signal to produce an output compressed video bitstream having a second format and having a second bitrate, said compressing responsive at least to information in said second bitstream.

2. The method of claim 1, wherein said intermediate format video signal comprises a plurality of decoded macroblocks and mode refinement information for each of the plurality decoded macroblocks.

3. The method in claim 2, wherein said second bitstream includes motion vector information for each inter-coded macroblock in the intermediate format video signal.

4. The method in claim 2, wherein the compressing is performed without motion vector search for the plurality of decoded macroblocks.

5. The method of claim 1, wherein said second bitstream comprises a pass-through syntax bitstream.

6. The method in claim 2, wherein the decompressing is performed without deblocking.

7. The method in claim 6, wherein the compressing is performed without deblocking the plurality of decoded macroblocks.

8. Video transcoding apparatus, comprising:
a processor;
a data bus; and
a computer-readable memory;
wherein the processor is configured to:
receive an input compressed video bitstream having a first format and having a first bitrate;
parse the input compressed video bitstream to generate a second bitstream;
decompress the input compressed video bitstream to produce an intermediate format video signal;
process the intermediate format video signal;
compress the intermediate format video signal to produce an output compressed video bitstream having a second format and having a second bitrate, said compressing responsive at least to information in said second bitstream; said second bitrate responsive to the said first bitrate and a target transrating bitrate.

9. The apparatus of claim 8, wherein said intermediate format video signal comprises a plurality of decoded macroblocks and mode information for each of the plurality of decoded macroblocks.

10. The apparatus of claim 9 wherein said mode information comprises intra encoding modes for at least some of the plurality of decoded macroblocks.

11. The apparatus of claim 9, wherein the compressing preserves an encoding mode of substantially all macroblocks in the input compressed video bitstream.

12. The apparatus of claim 9, wherein the decompressing is performed without performing a deblocking operation on any macroblock in the input compressed video bitstream.

13. The apparatus of claim 11, wherein the compressing is performed without performing a deblocking operation on any macroblock in the output compressed video bitstream.

14. A video transrating method, comprising:
decoding an input video bitstream to generate a first residual signal having a first temporal location;
generating a second residual signal responsive to the first residual signal and a value of a first intermediate signal having a temporal location earlier in time than the first temporal location;
requantizing and retransforming the second residual signal to form a second intermediate signal;
filtering the second intermediate signal to generate a third intermediate signal; and
reconstructing and motion compensating the third intermediate signal to re-generate a value of the first intermediate signal corresponding having the first temporal location.

15. The method of claim 14, wherein said reconstructing is responsive to mode refinement information extracted from the input video bitstream.

16. The method of claim 19 wherein, said motion compensating is responsive to an intra-predicted signal generated from said second intermediate signal.

17. A method of transrating signals, comprising:
providing a video bitstream having a first bitrate associated therewith;
processing said video bitstream utilizing temporal and spatial correlation; and
generating an output bitstream having a second bitrate different than said first bitrate;
wherein said processing said video bitstream utilizing temporal and spatial correlation decodes a plurality of macroblocks comprising the video bitstream to a partially decoded intermediate format.

18. The method of claim 17, further comprising:
extracting a plurality of header bits from the video bitstream; and
inserting the plurality of header bits in the output bitstream.

19. The method of claim 17, wherein the partially decoded intermediate format is calculated without performing motion compensation on the plurality of macroblocks.
